(19) United States
(12) Patent Application Publication
(10) Pub. No.: US 2026/0161000 A1
(43) Pub. Date: Jun. 11, 2026

(54) WAVEGUIDE STRUCTURE

(71) Applicant: INDUSTRIAL TECHNOLOGY RESEARCH INSTITUTE, HSINCHU (TW)

(72) Inventors: Chy-Lin WANG, Hsinchu County (TW); Tai-Yuan YEH, Miaoli County (TW); Hsueh-Chih CHANG, Changhua County (TW)

(21) Appl. No.: 18/979,674

(22) Filed: Dec. 13, 2024

(30) Foreign Application Priority Data
Dec. 11, 2024 (TW) 113148107

(51) Int. Cl. G02B 27/01; G02B 6/124

(52) U.S. Cl. CPC G02B 27/0172; G02B 6/124

(57) ABSTRACT

A waveguide structure includes a substrate. The waveguide structure further includes an input grating region, a fold grating region and an output grating region. Each of the input grating region, the fold grating region and the output grating region includes a plurality of meta-grating units. Each of the meta-grating units includes a first grating and a second grating.

### BACKGROUND

### Field of Invention

The present disclosure relates to waveguide structures.

### Description of Related Art

A waveguide structure can be used to implement displays in head-mounted display devices. For example, the waveguide structure can be positioned in front of the user's line of sight in a head-mounted display device. The image source of the head-mounted display device emits light that includes the image towards the waveguide structure, which then transmits the image via light to the area in front of the user's line of sight. In some embodiments, the waveguide structure used to adjust the light may include tilted gratings with varying depths.

However, the manufacturing process for tilted gratings is challenging, and these gratings are highly sensitive to the tolerances of their depth and angle, which can lead to issues such as stray light, eye glow, or image misalignment.

### SUMMARY

An aspect of the present disclosure relates to a waveguide structure.

According to one or more embodiments of the present disclosure, a waveguide structure includes a substrate, an input grating region on the substrate and including a plurality of input meta-grating units arranged periodically, a fold grating region on the substrate and including a plurality of fold meta-grating units arranged periodically and an output grating region on the substrate and including a plurality of output meta-grating units arranged periodically. The input grating region and the fold grating region are arranged along a first direction. The output grating region is located at a side of the fold grating region. The fold grating region and the output grating region arranged along a second direction different from the first direction. Each of the input meta-grating units, the fold meta-grating units and the output meta-grating unit includes a first grating and a second grating. In a periodic length of each of the input meta-grating units, the fold meta-grating units and the output meta-grating units, the first grating in a cross-sectional view has a first profile, the second grating in the cross-sectional view has a second profile, the first profile is at a first boundary of the periodic length and has a first width, the second profile has a second width, a first gap is between the first profile and the second profile, the second profile is spaced apart from a second boundary of the periodic length from a second gap, the first width is equal to or greater than the second width, and a ratio of the first gap and the second gap is in a range 0.1 to 10.

An aspect of the present disclosure relates to a waveguide structure.

According to one or more embodiments of the present disclosure, a waveguide structure includes a substrate, an input grating region on the substrate and including a plurality of input meta-grating units arranged periodically, a fold grating region on the substrate and including a plurality of fold meta-grating units arranged periodically and an output grating region on the substrate and including a plurality of output meta-grating units arranged periodically. The input grating region and the fold grating region are arranged along a first direction. The output grating region is located at a side of the fold grating region. The fold grating region and the output grating region arranged along a second direction different from the first direction. Each of the input meta-grating units, the fold meta-grating units and the output meta-grating unit includes a first grating and a second grating. Each of the input meta-grating units, the fold meta-grating units and the output meta-grating units comprises a first grating and a second grating, top surfaces of the first and second gratings of the input meta-grating units, the fold meta-grating units and the output meta-grating units have the same height.

In summary, the waveguide structure with meta-gratings is capable of controlling the propagation of electromagnetic waves to achieve diffraction, bending, and light emission. The meta-gratings at various positions can be fabricated through a single etching process and can have the same height. In addition, using meta-grating for electromagnetic wave control allows for high tolerance to etching deviations.

The above description is merely intended to explain the problems that the present disclosure aims to address, the technical means for solving these problems, and the resulting effects. The specific details of the present disclosure will be thoroughly introduced in the following embodiments and the associated figures.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a schematic structural diagram of a display device according to one or more embodiments of the present disclosure;

FIG. 1B illustrates an exemplary top view of a waveguide structure according to one or more embodiments of the present disclosure;

FIG. 1C illustrates l cross-sectional views of the input grating region, fold grating region, and output grating region on a substrate according to one or more embodiments of the present disclosure;

FIG. 2A illustrates a meta-grating unit of the input grating region according to one or more embodiments of the present disclosure;

FIG. 2B illustrates a diagram showing diffraction efficiency of the transmissive or reflective diffraction light with different orders at different incident angles for the input grating region depicted in FIG. 2A;

FIG. 3A illustrates a meta-grating unit of the fold grating region according to one or more embodiments of the present disclosure;

FIG. 3B illustrates a diagram showing diffraction efficiency of the transmissive or reflective diffraction light with different orders at different incident angles for the fold grating region depicted in FIG. 3A;

FIG. 4A illustrates a meta-grating unit of the fold grating region according to one or more embodiments of the present disclosure;

FIG. 4B illustrates a diagram showing diffraction efficiency of the transmissive or reflective diffraction light with different orders at different incident angles for the fold grating region depicted in FIG. 4A;

FIG. 5A illustrates a meta-grating unit of the output grating region according to one or more embodiments of the present disclosure;

FIG. 5B illustrates a diagram showing diffraction efficiency of the transmissive or reflective diffraction light with different orders at different incident angles for the fold grating region depicted in FIG. 5A;

FIG. 6A illustrates a meta-grating unit of the output grating region according to one or more embodiments of the present disclosure;

FIG. 6B illustrates a diagram showing diffraction efficiency of the transmissive or reflective diffraction light with different orders at different incident angles for the fold grating region depicted in FIG. 6A;

FIG. 7A illustrates a meta-grating unit of the output grating region according to one or more embodiments of the present disclosure;

FIG. 7B illustrates a diagram showing diffraction efficiency of the transmissive or reflective diffraction light with different orders at different incident angles for the fold grating region depicted in FIG. 7A;

FIG. 8A illustrates a meta-grating unit of the output grating region according to one or more embodiments of the present disclosure;

FIG. 8B illustrates a diagram showing diffraction efficiency of the transmissive or reflective diffraction light with different orders at different incident angles for the fold grating region depicted in FIG. 8A;

FIG. 9A illustrates a meta-grating unit of the output grating region according to one or more embodiments of the present disclosure;

FIG. 9B illustrates a diagram showing diffraction efficiency of the transmissive or reflective diffraction light with different orders at different incident angles for the fold grating region depicted in FIG. 9A;

FIG. 10 illustrates a structural schematic diagram of a display device according to one or more embodiments of the present disclosure;

FIGS. 11A to 11E illustrate various meta-grating units according to embodiments of the present disclosure;

FIG. 11F illustrates a cross-sectional view of the meta-grating units of FIGS. 11A to 11E; and

FIGS. 12 through 15 illustrate various meta-grating units according to embodiments of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations. Also, the same labels may be regarded as the corresponding components in the different drawings unless otherwise indicated. The drawings are drawn to clearly illustrate the connection between the various components in the embodiments, and are not intended to depict the actual sizes of the components.

In addition, terms used in the specification and the claims generally have the usual meaning as each terms are used in the field, in the context of the disclosure and in the context of the particular content unless particularly specified. Some terms used to describe the disclosure are to be discussed below or elsewhere in the specification to provide additional guidance related to the description of the disclosure to specialists in the art.

The phrases “first,” “second,” etc., are solely used to separate the descriptions of elements or operations with the same technical terms, and are not intended to convey a meaning of order or to limit the disclosure.

Additionally, the phrases “comprising,” “includes,” “provided,” and the like, are all open-ended terms, i.e., meaning including but not limited to.

Further, as used herein, “a” and “the” can generally refer to one or more unless the context particularly specifies otherwise. It will be further understood that the phrases “comprising,” “includes,” “provided,” and the like used herein indicate the stated characterization, region, integer, step, operation, element and/or component, and does not exclude additional one or more other characterizations, regions, integers, steps, operations, elements, components and/or groups thereof.

The present disclosure relates to a waveguide structure featuring a meta-grating and a display device using the waveguide structure. A meta-grating may have a grating structure with dimensions near the wavelength of visible light and arranged periodically. In some embodiments, by designing the size of individual grating structures of the meta-grating or the periodic arrangement of the grating structures, it is possible to adjust electromagnetic wave properties. The meta-grating can be used, for example, in augmented reality display devices. Image light emitted from an image source of the display device can couple with a transparent substrate through the meta-grating, facilitating diffraction, fold, and light output for users to view augmented reality images. In one or more embodiments of the present disclosure, the meta-grating is formed on a substrate, with the grating structures of the meta-grating extending vertically upward from the surface of the substrate, and these grating structures may have the same height relative to a surface of the substrate. In some embodiments, the grating structures of the meta-grating can be formed by etching the same layer of grating material. In one or more embodiments of the present disclosure, the meta-grating exhibits high tolerance to variations in etching depth.

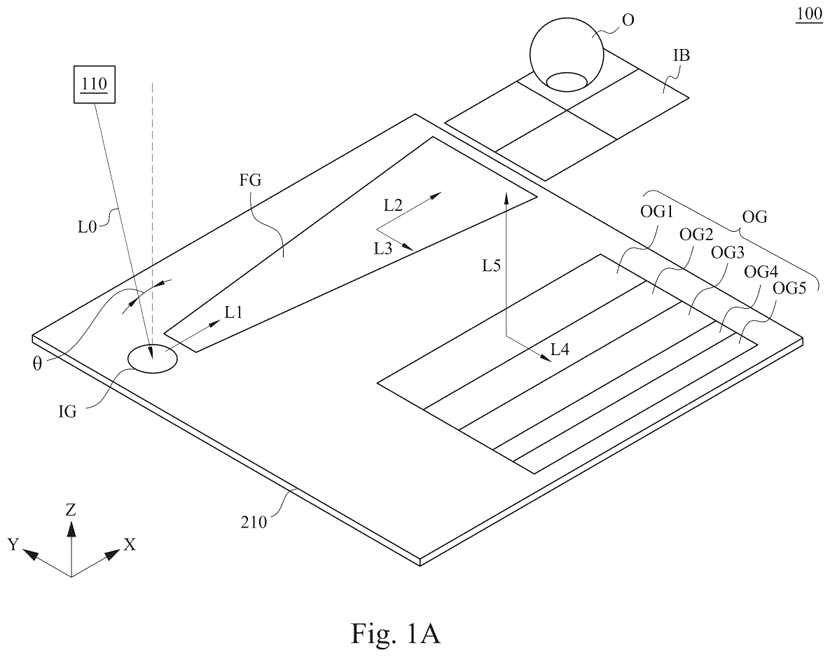

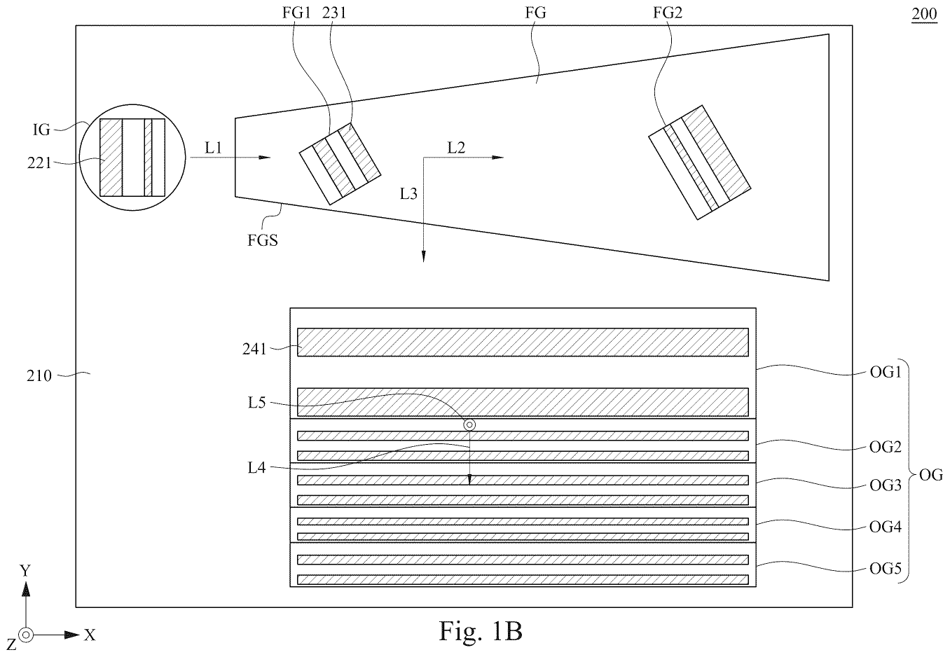

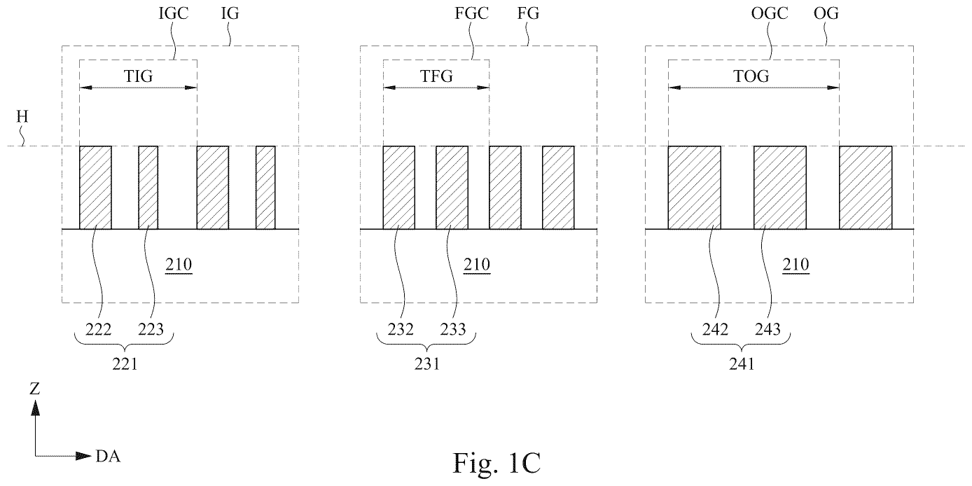

Reference is made to FIG. 1A. FIG. 1A illustrates a schematic structural diagram of a display device 100 according to one or more embodiments of the present disclosure. As illustrated in FIG. 1A, the display device 100 includes an image source 110 and a waveguide structure 200. The waveguide structure 200 includes a substrate 210, which may be a transparent substrate with a refractive index that allows total internal reflection of electromagnetic waves within the substrate. The waveguide structure 200 also includes an input grating region IG, a fold grating region FG, and an output grating region OGon the substrate 210. In some implementations, as shown in FIG. 1A, the output grating region OG may consist of multiple output grating sub-regions OG1, OG2, OG3, OG4, and OG5. In one or more implementations disclosed herein, each of the input grating region IG, the fold grating region FG, and the multiple output grating sub-regions OG1, OG2, OG3, OG4, and OG5 of the output grating region OG can include multiple meta-grating units (cells), which are capable of modulating the image light emitted from the image source 110.

For purposes of convenient illustration, FIG. 1A does not depict the meta-grating units. Please refer to FIG. 1B for the waveguide structure 200, which includes multiple meta-grating units. FIG. 1B illustrates an exemplary top view of a waveguide structure 200 according to one or more embodiments of the present disclosure FIG. 1B schematically illustrates multiple meta-grating units in the input grating region IG, the fold grating region FG, and several output grating sub-regions OG1, OG2, OG3, OG4, and OG5 of the output grating region OG. For purposes of convenient illustration, FIG. 1B schematically illustrates at least one set of meta-grating units in each of the input grating region IG, the fold grating region FG, and the output grating sub-regions OG1, OG2, OG3, OG4, and OG5 of the output grating region OG. The input grating region IG includes multiple gratings 221. The gratings 221 can extend parallel to each other in the Y direction. In some embodiments, the gratings 221 of the input grating region IG form a periodic arrangement of the meta-grating units. As shown in FIG. 1B, in some embodiments, the gratings 221 of the input grating region IG can be arranged along the X direction.

The fold grating region FG can include multiple gratings 231, which form a periodic arrangement of several meta-grating units. In some embodiments, as shown in FIG. 1B, these gratings 231 in the fold grating region FG can be arranged in a direction different from both the X and Y directions. For example, the gratings 231 in the fold grating region FG can be arranged on the X-Y plane in a direction that is rotated 45 degrees counterclockwise from the X direction. The gratings 231 can extend parallel to each other in a direction perpendicular to their arrangement direction. In some embodiments, the fold grating region FG may include a front-end fold grating sub-region FG1, a back-end fold grating sub-region FG2, and one or more middle fold grating sub-regions positioned between FG1 and FG2. Each of the front-end fold grating sub-region FG1, the back-end fold grating sub-region FG2, and the middle fold grating sub-regions can include meta-grating units arranged periodically.

The output grating region OG includes multiple output grating sub-regions OG1, OG2, OG3, OG4, and OG5, each including several gratings 241. The gratings 241 extend parallel to one another in the X direction. The gratings 241 within the output grating sub-regions OG1, OG2, OG3, OG4, and OG5 form a periodic arrangement of several meta-grating units. In some embodiments, as illustrated in FIG. 1B, the gratings 241 are arranged in the Y direction. In some embodiments, the meta-grating units in different output sub-regions OG1, OG2, OG3, OG4, and OG5 are designed to have different diffraction efficiencies.

Reference is made to FIGS. 1A and 1B. In one or more embodiments, the waveguide structure 200 is designed to perform a two-dimensional eye-box expansion of the image light emitted by the image source 110. As shown in FIG. 1A, the image source 110 is positioned along the Z direction atop the waveguide structure 200. The image source 110 emits light containing the image, denoted as light beam L0, at an incident angle θ towards the input grating region IG of the waveguide structure 200. The meta-grating units within the input grating region IG function as a diffraction grating, causing the light beam L0 to be diffracted and folded into the substrate 210. Once the light beam L0 is transmitted inside the substrate 210 through the input grating region IG, the light beam L0 undergoes 1st order transmissive diffraction and is modulated (such as via grating 221) into light beam L1. The light beam L1 propagates through the substrate 210 via total internal reflection in the X direction and enters the fold grating region FG. The fold grating region FG features meta-grating units that act as reflective diffraction gratings, converting the light beam L1 into a two-dimensional diffraction path. Entering the fold grating region FG, the light beam L1 is modulated (e.g., via grating 231) into the light beams L2 and L3. The light beam L2, for example, is a 0th order reflective diffraction beam that propagates into the fold grating region FG in the X direction by total reflection. For example, the light beam L2 can propagates through a front-end fold grating sub-region FG1, one or more middle fold grating sub-regions between the front-end fold grating sub-region FG1 and a back-end fold grating sub-region FG2 and the back-end fold grating sub-region FG2 in order. The light beam L3, for example, is a −1st order (negative first order) reflective diffraction light beam that propagates within the substrate 210 in the negative Y direction. The light beam L3 can exit through the exit side FGS of the fold grating region FG and then propagate toward the output grating region OG. As the light beam L2 travels within the fold grating region FG, multiple sets of light beams L3 will exit from different positions of the exit side FGS on the X-direction to the output grating region OG, thereby achieving image pupil expansion in the X direction. The meta-grating units of the output grating region OG are transmissive diffraction gratings. After entering the output grating region OG, the light beam L3 is converted into a two-dimensional path diffraction. After entering the output grating region OG, the light beam L3 is modulated (for example, by the grating 241) into light beams L4 and L5. The light beam L4, for example, is a 0th order reflective diffraction light beam that propagates in the negative Y direction. The light beam L5 is, for example, is a 1st order transmissive diffraction light beam, which is coupled out of the substrate 210 through the output grating region OG and exits in the vertical Z direction. The output grating region OG includes multiple output grating sub-regions OG1, OG2, OG3, OG4, and OG5. The light beam L4 can sequentially pass through the output grating sub-regions OG1, OG2, OG3, OG4, and OG5. The output grating sub-regions OG1, OG2, OG3, OG4, and OG5 have different diffraction efficiency characteristics for various types and orders of diffraction light, enabling the light beam L5 to be emitted from different positions in the negative Y direction as the light beam L4 progresses in the negative Y direction, so that the pupil expansion in the Y direction is achieved. Therefore, the light beam L0, emitted from the image source 110, passes through the input grating region IG, the fold grating region FG, and the output grating region OG, allowing the light beam L5 to exit from different positions in both the X and Y directions of the output grating region OG. The user's pupil O views the display device 100 in the Z direction. The light beam L5, exiting from the waveguide structure 200, forms multiple image boxes IB in front of the pupil O. These different image boxes IB correspond to the images of light beam L0 after two-dimensional pupil expansion at various positions in front of the pupil O. As the position of the user's pupil O shifts, the user's pupil O receives images from different image boxes IB.

FIG. 1C illustrates local cross-sectional views of the input grating region IG, fold grating region FG, and output grating region OG on a substrate 210 according to one or more embodiments of the present disclosure. For the purpose of facilitating explanation, FIG. 1C respectively illustrates multiple cross-sectional views along individual periodic arrangement directions DA of the grating 221 in the input grating region IG, the grating 231 in the fold grating region FG, and the grating 241 in the output grating region OG.

For example, referring to FIGS. 1B and 1C, the arrangement direction DA of the grating 221 in the input grating region IG can be the X direction, the arrangement direction DA of the grating 231 in the fold grating region FG can be a direction rotated 45 degrees relative to the X direction, and the arrangement direction DA of the grating 241 in the output grating region OG can be the Y direction. The local cross-sectional view of the input grating region IG includes input meta-grating units IGC with a periodic length TIG. The grating 221 of the input meta-grating units IGC includes a first grating 222 and a second grating 223 on the substrate 210. The first grating 222 is located at one of boundaries of the input meta-grating units IGC. The second grating 223 is spaced apart from the first grating 222 within the periodic length TIG. The local cross-sectional view of the fold grating region FG includes fold meta-grating units FGC with a periodic length TFG. The grating 231 of the fold meta-grating units FGC includes a first grating 232 and a second grating 233 on the substrate 210. The first grating 232 is positioned at one of the boundaries of the fold meta-grating units FGC. The second grating 233 is spaced apart from the first grating 232 within the periodic length TFG. The local cross-sectional view of the output grating region OG includes output meta-grating units OGC with a periodic length TOG. The grating 241 of the output meta-grating units OGC includes a first grating 242 and a second grating 243 on the substrate 210. The first grating 242 is located at one of the boundaries of the output meta-grating units OGC, and the second grating 243 is spaced apart from the first grating 242 within the periodic length TOG.

FIG. 1C illustrates the formation of the grating 221 in the input grating region IG, the grating 231 in the fold grating region FG, and the grating 241 in the output grating region OG on the substrate. For example, in one or more embodiments of the present disclosure, a grating material layer may be formed on the substrate 210. The grating material layer, for example, can be formed on the substrate 210 through a suitable deposition process. The formation of the grating material layer may also include polishing the grating material layer so that the top surface of the grating material layer is flat. Subsequently, a patterning process is performed to the grating material layer. The patterning of the grating material layer can include forming an etching pattern mask layer on the grating material layer and etching the grating material layer based on the mask layer. Therefore, the grating 221 in the input grating region IG, the grating 231 in the fold grating region FG, and the grating 241 in the output grating region OG can all be defined in a single etching process. As illustrated in FIG. 1C, the multiple top surfaces of the formed gratings 221, 231, and 241 can have the same height H relative to the top surface of the substrate 210. In some embodiments, due to grating pattern design, etching variations may occur in the input grating region IG, fold grating region FG, and output grating region OG, resulting in different heights H of the multiple top surfaces of gratings 221, 231 and 241 relative to the substrate 210. In some embodiments, the height H can range from 200 nm to 500 nm.

In some embodiments, the substrate 210 is a transparent substrate with a refractive index greater than 1.7 for diffraction light entering it. In some embodiments, the refractive index of the substrate 210 is, for example, 2. In some embodiments, the gratings 221, 231 and 241 have a refractive index greater than 1.7 for diffraction light entering the gratings 221, 231 and 241. In some embodiments, the refractive index of the gratings 221, 231 and 241 is, for example, 2.6. In some embodiments, the material of the substrate 210 includes, for example, gallium phosphide (GaP). In some embodiments, the grating materials for 221, 231 and 241 include silicon oxide or silicon nitride. In some embodiments, the grating materials for 221, 231, and 241 include materials like gallium nitride (GaN), gallium phosphide (GaP), aluminum arsenide (AlAs), aluminum gallium arsenide (AlGaAs), titanium dioxide (TiO2), silicon (Si), or silicon nitride (Si3N4). In some embodiments, the grating material for 221, 231, and 241 can be the same as the material of the substrate 210.

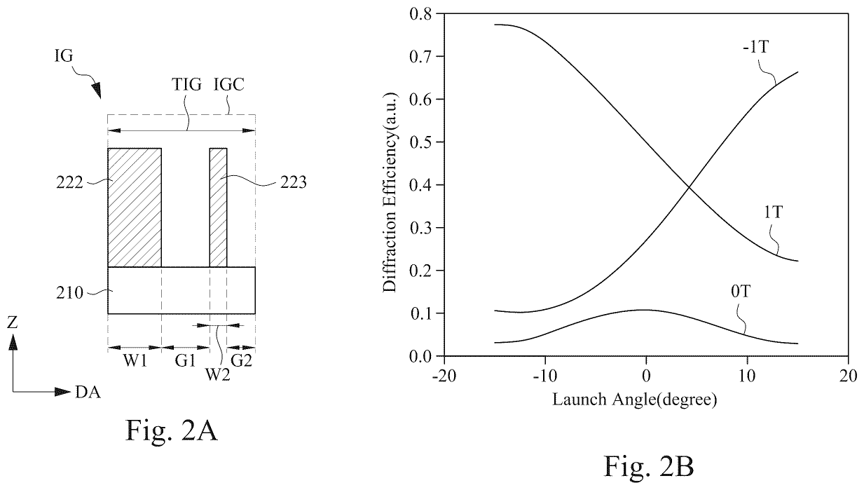

Reference is made to FIG. 2A. FIG. 2A illustrates a meta-grating unit IGC of the input grating region IG according to one or more embodiments of the present disclosure. In FIG. 2A, the first grating 222 is located at the boundary of the meta-grating units IGC. Within the periodic length TIG of the meta-grating unit IGC, the first grating 222 has a width W1 in the arrangement direction DA (e.g., the X direction in FIG. 1B). The first grating 222 is spaced from the second grating 223 by a gap G1 in the arrangement direction DA. The second grating 223 has a width W2 in the arrangement direction DA and is spaced from the boundary of the meta-grating unit IGC by a gap G2. In some embodiments, as shown in FIG. 2A, the width W1 is greater than the width W2, and the gap G1 is greater than the gap G2. Thus, multiple meta-grating units IGC are periodically arranged in the arrangement direction DA with a periodic length TIG, forming the input grating region IG.

FIG. 2B illustrates a diagram showing diffraction efficiency of the transmissive or reflective diffraction light with different orders at different incident angles θ (e.g., the incident angles θ as illustrated in FIG. 2B) for the input grating region depicted in FIG. 2A. The horizontal axis of FIG. 2B corresponds to the incident angle θ, measured in degrees. In FIG. 2B, the vertical axis corresponds to diffraction efficiency, measured in arbitrary units (abbreviated as a.u.). The curves 0T, 1T, and −1T represent the 0th, 1st, and −1st order transmissive diffraction light, respectively. In FIG. 2B, the diffraction efficiency of the 0th order transimissive diffraction light is suppressed to reduce RGB misalignment, resulting in the diffraction efficiencies of 1T and −1T order transimissive diffraction light being greater than the diffraction efficiencies of the 0th order within the range of incident angles. The 1T and −1T order transimissive diffraction light exhibit a larger slope relative to the range of incident angles, enhancing uniformity. The 1T and −1T order transimissive diffraction light have primary diffraction efficiency, reducing the mixing of light from other order transmissive or reflective diffraction light.

In some embodiments, within the input meta-grating units IGC of the input grating region IG, the width W1 is greater than the width W2, and the gap G1 is greater than the gap G2. In some embodiments, for the input meta-grating units IGC in the input grating region IG, the ratio of the periodic length TIG to the width W1 ranges from 2.4 to 2.8, the ratio of the periodic length TIG to the gap G1 ranges from 2.7 to 3.9, the ratio of width W1 to width W2 ranges from 2.7 to 3.8, and the ratio of gap G1 to gap G2 ranges from 1.1 to 2.8. In some embodiments, the diffraction efficiency is designed to gradually decrease as the air incident angle θ varies from −15 degrees to +15 degrees.

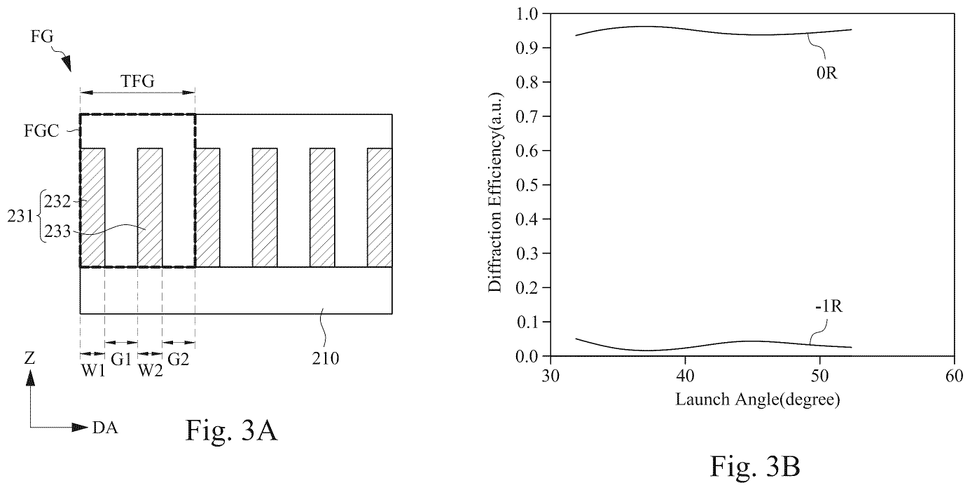

Reference is made to FIG. 3A. FIG. 3A illustrates a meta-grating unit FGC of the fold grating region FG according to one or more embodiments of the present disclosure. FIG. 3A illustrates a plurality of gratings 231. In FIG. 3A, the first grating 232 is located at the boundary of the meta-grating units FGC. Within the periodic length TFG of the meta-grating units FGC, the first grating 232 has a width W1 in the arrangement direction DA (e.g., the arrangement direction of grating 231 as shown in FIG. 1B). The first grating 232 is spaced from the second grating 233 by a gap G1 in the arrangement direction DA. The second grating 233 has a width W2 in the arrangement direction DA and is spaced from the boundary of the meta-grating units FGC by a gap G2. In some embodiments, as shown in FIG. 3A, the width W1 is approximately equal to, or exactly equal to, the width W2, and the gap G1 is greater than the gap G2. Thus, the multiple meta-grating units FGC are periodically arranged in the arrangement direction DA with a periodic length TFG, forming the fold grating region FG.

FIG. 3B illustrates a diagram showing diffraction efficiency of the transmissive or reflective diffraction light with different orders at different incident angles for the fold grating region depicted FG in FIG. 3A. The horizontal axis of FIG. 3B corresponds to the incident angle θ, measured in degrees. In FIG. 3B, the vertical axis corresponds to diffraction efficiency, measured in arbitrary units (abbreviated as a.u.). The curves 0R and −1R in FIG. 3B correspond to the 0th and −1st order reflective diffraction light, respectively. Within the range of incident angles depicted in FIG. 3B, the diffraction efficiency of the 0th order reflective refraction light is greater than the diffraction efficiencies of the −1st order reflective refraction light. Additionally, the diffraction efficiency of the 0th order reflective refraction light is greater than the diffraction efficiencies of other order reflective or transmissive diffraction light, while maintaining good uniformity.

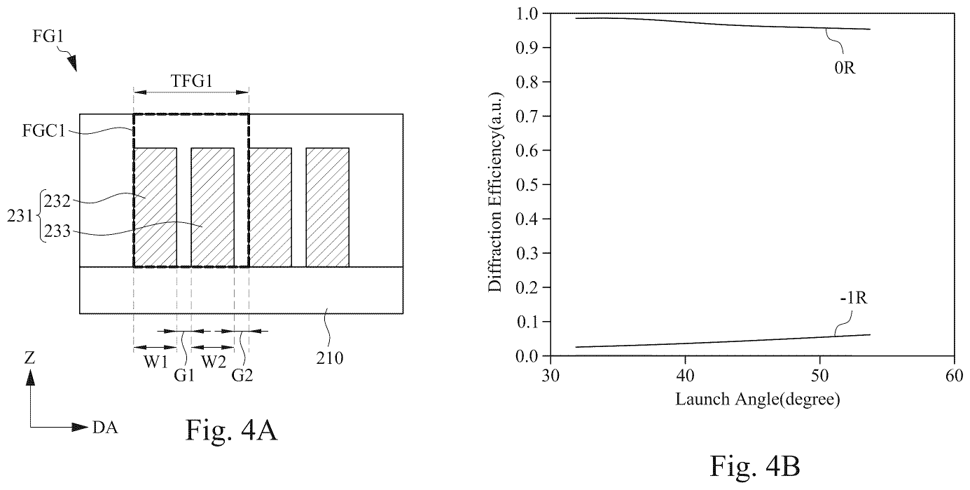

Reference is made to FIG. 4A. FIG. 4A illustrates the meta-grating units FGC1 of the fold grating sub-region FG1, such as the front-end fold grating sub-region FG1 shown in FIG. 1B, according to one or more embodiments of the present disclosure. Compared to the meta-grating units FGC in the fold grating region FG shown in FIG. 3A, the meta-grating units FGC1 in the fold grating sub-region FG1 in FIG. 4A have a periodic length TFG1 where the width W1 is greater than the width W2, and the gap G1 is equal to the gap G2. FIG. 4B illustrates a diagram of the relationship between different orders of transmissive or reflective diffraction light and diffraction efficiency for various incident angles corresponding to the fold grating region FG depicted in FIG. 4A. In FIG. 4B, it can still be ensured that, within a specific range of incident angles, the diffraction efficiency of the 0th order reflected diffraction light is greater than the diffraction efficiencies of the −1st order reflective diffraction light. Further, the diffraction efficiency of the 0th order reflective diffraction light is greater than the diffraction efficiencies of other order reflective or transmissive diffraction light and has good uniformity. In other words, the fold grating region FG of FIG. 3A and the fold grating sub-region FG1 of FIG. 4A can have similar optical effects, thereby offering good design flexibility.

In some embodiments, such as in the meta-grating units FGC1 of the front-end fold grating sub-region FG1 depicted in FIG. 1B, the width W1 is approximately equal to the width W2, and the gap G1 is approximately equal to the gap G2. In some embodiments, the ratio of the periodic length TFG1 to the width W1 ranges from 2.6 to 6.2, the ratio of the periodic length TFG1 to the gap G1 ranges from 2.6 to 7, the ratio of width W1 to width W2 can equal 1 or range from 1 to 1.2, and the ratio of gap G1 to gap G2 ranges from 0.8 to 1.2.

In some embodiments, within the meta-grating units FGC of the back-end fold grating sub-region FG2 depicted in FIG. 1B, the width W1 is greater than the width W2, and the gap G1 is not equal to the gap G2. In some embodiments, the ratio of the periodic length TFG to the width W1 ranges from 4 to 6, the ratio of the periodic length TFG to the gap G1 ranges from 2 to 3.6, the ratio of width W1 to width W2 ranges from 1.02 to 3.4, and the ratio of gap G1 to gap G2 ranges from 0.8 to 1.6. In some embodiments, the back-end fold grating sub-region FG2 is designed to have a total internal reflection diffraction efficiency of less than 0.2 between angles of 32 to 53 degrees.

In some embodiments, the front-end fold grating sub-region FG1 and the back-end fold grating sub-region FG2 depicted in FIG. 1B, along with multiple fold grating sub-regions not shown in between, can have the same meta-grating units FGC design.

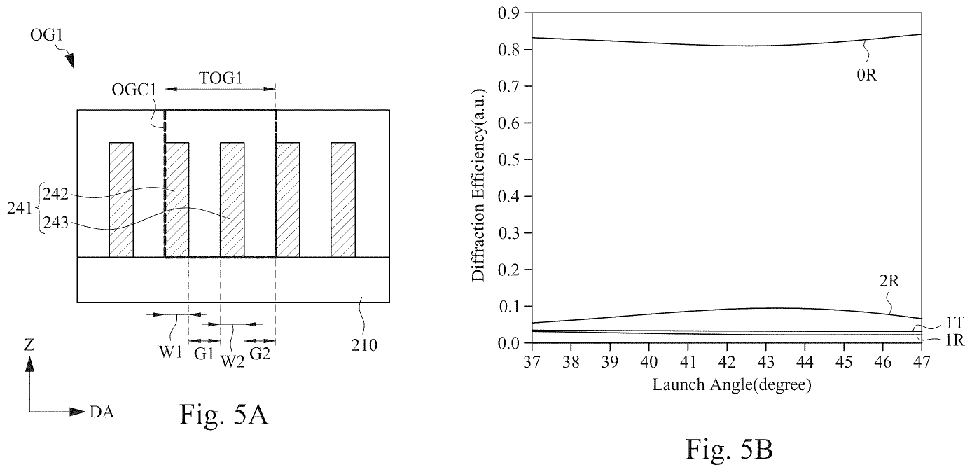

Reference is made to FIG. 5A. FIG. 5A illustrates a meta-grating unit OGC1 of the output grating sub-region OG1 according to one or more embodiments of the present disclosure. In FIG. 5A, the first grating 242 is located at the boundary of the meta-grating units OGC1. Within the periodic length TOG1 of the meta-grating units OGC1, the first grating 242 has a width W1 in the arrangement direction DA (e.g., the Y direction as shown in FIG. 1B). The first grating 242 is spaced from the second grating 243 by a gap G1 in the arrangement direction DA. The second grating 243 has a width W2 in the arrangement direction DA and is spaced from the boundary of the meta-grating units OGC1 by a gap G2. In some embodiments, as shown in FIG. 5A, the width W1 is equal to the width W2, and the gap G1 is greater than the gap G2. Thus, multiple meta-grating units OGC1 are periodically arranged in the arrangement direction DA with a periodic length TOG1, forming the output grating sub-region OG1.

FIG. 5B illustrates a diagram showing diffraction efficiency of the transmissive or reflective diffraction light with different orders at different incident angles for the output grating sub-region OG1 depicted in FIG. 5A. The horizontal axis of FIG. 5B corresponds to the incident angle θ, measured in degrees. In FIG. 5B, the vertical axis corresponds to diffraction efficiency, measured in arbitrary units (abbreviated as a.u.). In FIG. 5B, the curves 0R, 1R, and 2R represent the 0th, 1st, and 2nd order reflective diffraction light, respectively, while the curve 1T corresponds to the 1st order transmissive diffraction light. In FIG. 5B, the diffraction efficiency of the 0th order reflective refraction light is greater than the diffraction efficiencies of the 1st and 2nd order reflective refraction light and the 1st order transmitted light. Additionally, the diffraction efficiency of the 1st order transmitted light is greater than the diffraction efficiencies of the 1st order reflective refraction light, thus reducing the occurrence of eye glow effects.

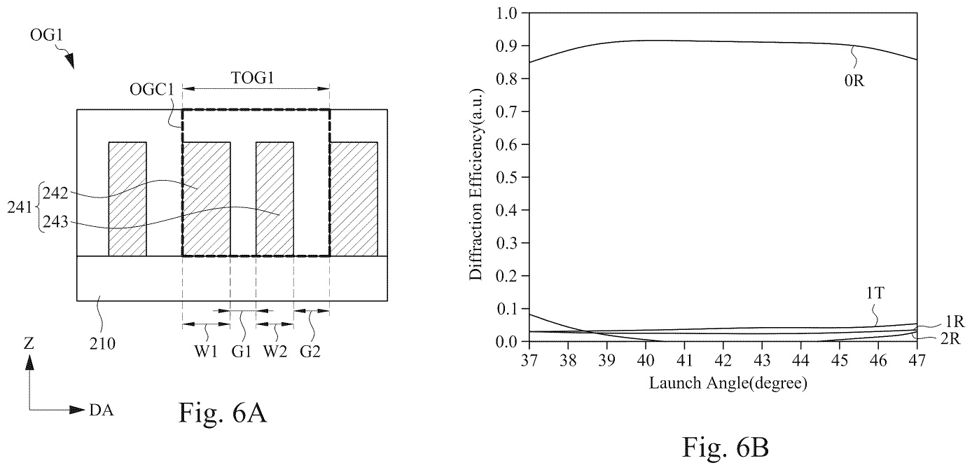

Reference is made to FIG. 6A. FIG. 6A illustrates the meta-grating units OGC1 of the output grating sub-region OG1 according to one or more embodiments of the present disclosure. Compared to the output grating sub-region OG1 shown in FIG. 5A, the meta-grating units OGC1 in the output grating sub-region OG1 of FIG. 6A have the same periodic length TOG1, but with increased widths W1 and W2, where width W1 is greater than width W2, and reduced gaps G1 and G2. FIG. 6B illustrates a diagram of the relationship between different orders of transmissive diffraction light and reflective diffraction light and their diffraction efficiencies for various incident angles corresponding to the output grating sub-region OG1 shown in FIG. 6A. In FIG. 6B, it is ensured that, within a specific range of incident angles, the diffraction efficiency of the 0th order reflective diffraction light is greater than the diffraction efficiencies of the 1st and 2nd order reflective diffraction light and the 1st order transmissive diffraction light.

In some embodiments, within the meta-grating units OGC1 of the output grating sub-region OG1, the width W1 is approximately equal to the width W2, and the gap G1 is approximately equal to the gap G2. In some embodiments, the ratio of the periodic length TOG1 to the width W1 ranges from 3.8 to 12, the ratio of the periodic length TOG1 to the gap G1 ranges from 2.3 to 3.9, the ratio of width W1 to width W2 is equal to 1 or ranges from 1 to 1.4, and the ratio of gap G1 to gap G2 ranges from 1 to 10. In some embodiments, the width W1 is less than the gap G1.

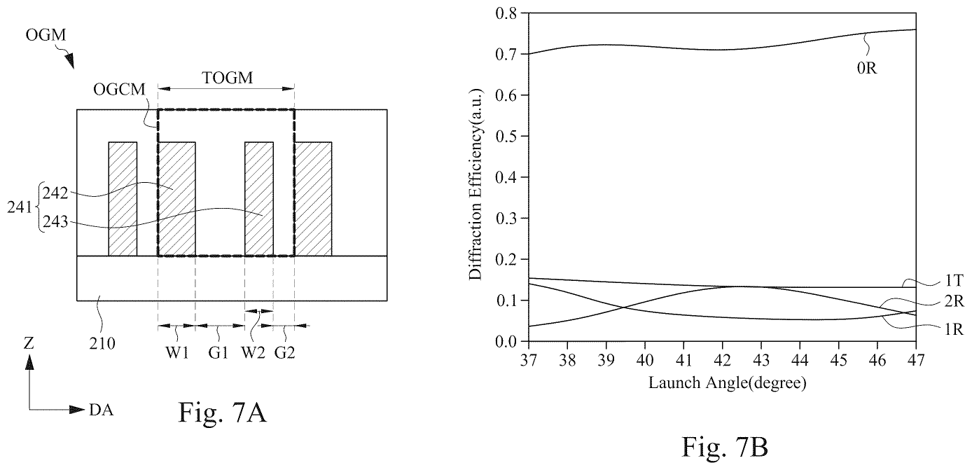

Reference is made to FIG. 7A. FIG. 7A illustrates the meta-grating units OGCM of an output grating sub-region OGM according to one or more embodiments of the present disclosure. The output grating sub-region OGM represents one of the middle output grating sub-regions OGM located between the output grating sub-region OG1 and output grating sub-region OG5 shown in FIG. 1B. For example, the middle output grating sub-region OGM can be output grating sub-regions OG2, OG3, or OG4 as illustrated in FIG. 1B. In FIG. 7A, the first grating 242 is positioned at the boundary of the meta-grating units OGCM. Within the periodic length TOGM of the meta-grating units OGCM, the first grating 242 has a width W1 along the arrangement direction DA (e.g., the Y direction in FIG. 1B). The first grating 242 is separated from the second grating 243 by a gap G1 along the arrangement direction DA. The second grating 243 has a width W2 along DA and is separated from the boundary of the meta-grating units OGCM by a gap G2. In some embodiments, as shown in FIG. 7A, the width W1 is greater than the width W2, and the gap G1 is greater than the gap G2. Accordingly, multiple meta-grating units OGCM are periodically arranged along the arrangement direction DA with a periodic length TOGM, forming the output grating sub-region OGM.

FIG. 7B illustrates a diagram of the relationship between different orders of transmissive diffraction light and reflective diffraction light and their diffraction efficiencies for various incident angles corresponding to the output grating sub-region OGM shown in FIG. 7A. The horizontal axis of FIG. 7B represents the incident angle, measured in degrees. The vertical axis of FIG. 7B corresponds to the diffraction efficiency, measured in arbitrary units (abbreviated as a.u.). The curves 0R, 1R, and 2R in FIG. 7B represent the 0th, 1st, and 2nd order reflective diffraction light, respectively, and the curve 1T represents the 1st order transmissive diffraction light. In FIG. 7B, the diffraction efficiency of the 0th order reflective diffraction light is greater than the diffraction efficiencies of both the 1st and 2nd order reflective diffraction light and the 1st order transmissive diffraction light.

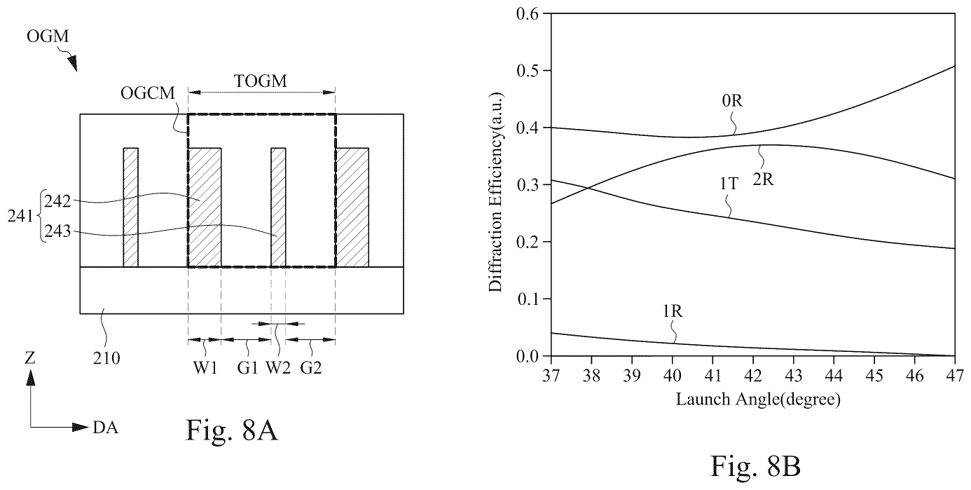

Reference is made to FIG. 8A. FIG. 8A illustrates the meta-grating units OGCM of an output grating sub-region OGM according to one or more embodiments of the present disclosure. The output grating sub-regions OGM in FIGS. 7A and 8A may correspond to different sub-regions among the output grating sub-regions OG2, OG3, and OG4 shown in FIG. 1B. For example, the output grating sub-region OGM in FIG. 7A can correspond to the output grating sub-region OG3 in FIG. 1B, and the output grating sub-region OGM in FIG. 8A can correspond to the output grating sub-region OG4. Compared to the output grating sub-region OGM in FIG. 7A, the meta-grating units OGC1 in the output grating sub-region OG1 of FIG. 8A have the same periodic length TOG1, with an increased width W1, a decreased width W2, an increased difference between the widths W1 and W2, and the gap G1 smaller than the gap G2. FIG. 8B illustrates a diagram of the relationship between different orders of transmitted diffraction light and reflected diffraction light and their diffraction efficiencies for various incident angles corresponding to the output grating sub-region OG1 shown in FIG. 8A. In FIG. 8B, it is still ensured that, within a specific range of incident angles, the diffraction efficiency of the 0th order reflective diffraction light is greater than the diffraction efficiencies of both the 1st and 2nd order reflective diffraction light and the 1st order transmissive diffraction light. However, the diffraction efficiencies of the 2nd order reflective diffraction light and the 1st order transmissive diffraction light are significantly increased.

In some embodiments, within the meta-grating units OGCM of the output grating sub-region OGM such as the output grating sub-regions OG2, OG3, and OG4 depicted in FIG. 1B, the width W1 is greater than width W2, and the gap G1 is not equal to gap G2. In some embodiments, the ratio of the periodic length TOGM to width W1 ranges from 1.5 to 5.3, the ratio of the periodic length TOGM to gap G1 ranges from 2.5 to 11, the ratio of width W1 to width W2 is approximately 1.1 or ranges from 1.1 to 3, and the ratio of gap G1 to gap G2 ranges from 0.7 to 2.2.

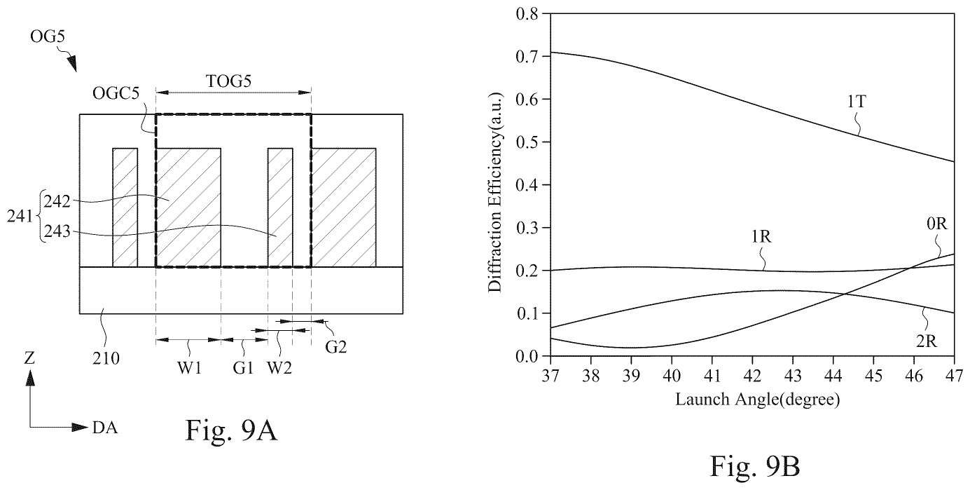

Reference is made to FIG. 9A. FIG. 9A illustrates the meta-grating units OGC5 of an output grating sub-region OG5 (e.g., the output grating sub-region OG5 shown in FIG. 1B) according to one or more embodiments of the present disclosure. In FIG. 9A, the first grating 242 is located at the boundary of the meta-grating units OGC5. Within the periodic length TOG5 of these meta-grating units, the first grating 242 has a width W1 along the arrangement direction DA (e.g., the Y direction in FIG. 1B). The first grating 242 is spaced from the second grating 243 by a gap G1 along the arrangement direction DA. The second grating 243 has a width W2 in the arrangement direction DA and is spaced from the boundary of the meta-grating units OGC5 by a gap G2. In some embodiments, as shown in FIG. 9A, the width W1 is greater than the width W2, and the gap G1 is greater than the gap G2. Accordingly, multiple meta-grating units OGC5 are periodically arranged along the arrangement direction DA with a periodic length TOG5, forming the output grating sub-region OG5.

FIG. 9B illustrates a diagram the relationship between different orders of transmissive diffraction light and reflective diffraction light and their diffraction efficiencies for various incident angles corresponding to the output grating sub-region OGM shown in FIG. 9A. The horizontal axis of FIG. 9B represents the incident angle, measured in degrees. The vertical axis of FIG. 9B corresponds to the diffraction efficiency, measured in arbitrary units (a.u.). The curves 0R, 1R, and 2R in FIG. 9B represent the 0th, 1st, and 2nd order reflective diffraction light, respectively. The curve 1T represents the 1st order transmissive diffraction light. In FIG. 9B, the diffraction efficiency of the 1st order transmissive diffraction light is greater than the diffraction efficiencies of the 0th, 1st, and 2nd order reflective diffraction light.

In some embodiments, within the meta-grating units OGC5 of the output grating sub-region OG5, the width W1 is greater than the width W2, and the gap G1 is greater than the gap G2. In some embodiments, the ratio of the periodic length TOG5 to the width W1 ranges from 2.4 to 2.8, the ratio of the periodic length TOG5 to the gap G1 ranges from 2.5 to 3.2, the ratio of width W1 to width W2 is approximately 2.1 or ranges from 2.1 to 3, and the ratio of gap G1 to gap G2 ranges from 2.5 to 3.1.

In some embodiments, the output grating sub-region OG1 can be considered the front-end output grating sub-region, and the output grating sub-region OG5 can be considered the back-end output grating sub-region. one or more intermediate output grating sub-regions OGM can be between the front-end output grating sub-region OG1 and the back-end output grating sub-region OG5. For example, but not limited to the present disclosure, as shown in FIG. 1B, the regions between OG1 and OG5 can include three output grating sub-regions OG2, OG3, and OG4. In some embodiments, from the front-end output grating sub-region OG1 to the back-end output grating sub-region OG5, the width W1 of the first grating 252 within the corresponding periodic length (such as any of the periodic lengths TOG1, TOGM, or TOG5) increases. For instance, the width W1 of the first grating 252 in the output grating sub-region OG2 is greater than the width W1 of the first grating 252 in the front-end output grating sub-region OG1, the width W1 in the output grating sub-region OG3 is greater than the width W1 of the first grating 252 in the output grating sub-region OG2, the width W1 in the output grating sub-region OG4 is greater than the width W1 of the first grating 252 in the output grating sub-region OG3, and the width W1 in the back-end output grating sub-region OG5 is greater than the width W1 of the first grating 252 in the output grating sub-region OG4.

Therefore, the output grating sub-region OG1, the output grating sub-regions OGM (such as OG2, OG3, and OG4), and the output grating sub-region OG5 can have different diffraction characteristics to achieve pupil expansion in one dimension.

In one or more embodiments, the periodic length of any of the meta-grating units IGC within the input grating region IG, the meta-grating units FGC of the fold grating region FG, which may include grating sub-regions such as grating sub-regions FG1 and FG2, and the meta-grating units OGC of the various output grating sub-regions OG1, OG2, OG3, OG4 and OG5 in the output grating region OG is within the range of 200 nm to 1600 nm.

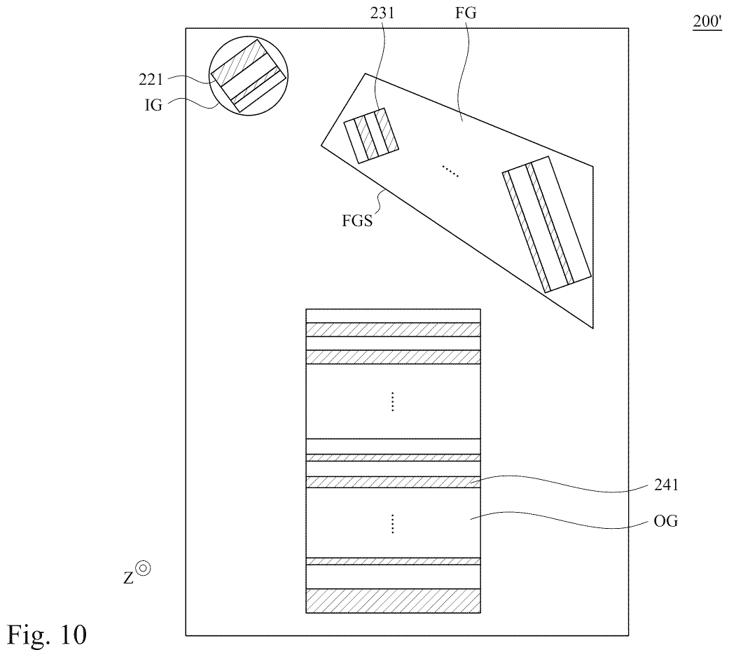

Reference is made to FIG. 10. FIG. 10 illustrates an exemplary top view of a waveguide structure 200′ in one or more embodiments of the present disclosure. Compared to the waveguide structure 200 in FIG. 1B, in the waveguide structure 200′ in FIG. 10, if the multiple gratings 241 in the output grating region OG are arranged along the Y direction, the multiple gratings 221 in the input grating region IG are arranged in a direction different from the X direction (e.g., rotated counterclockwise by 60 degrees relative to the Y direction), and the multiple gratings in the fold grating region FG are arranged in a direction different from both the X and Y directions (e.g., rotated counterclockwise by 120 degrees relative to the Y direction).

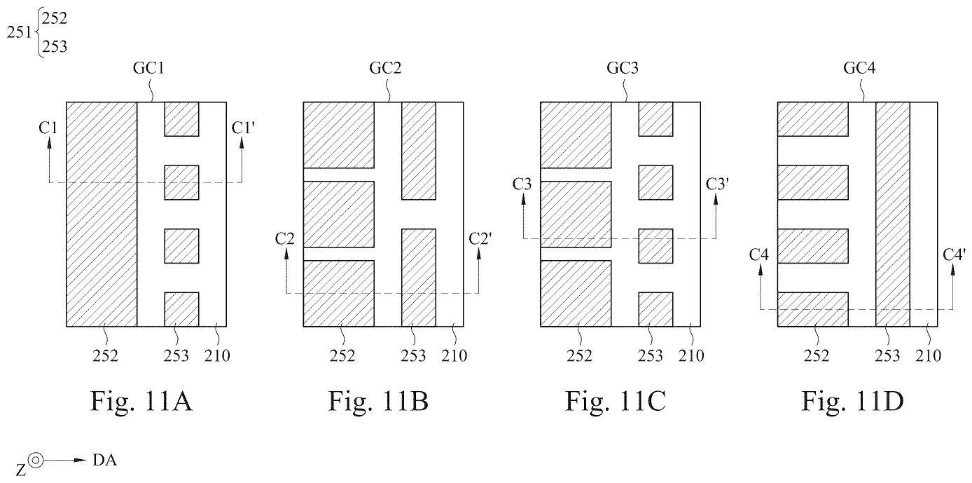

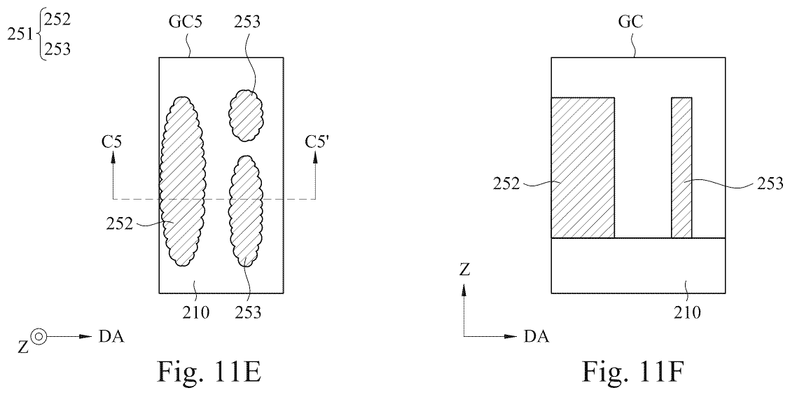

Reference is made to FIG. 11A through 11F. FIGS. 11A through 11E illustrates meta-grating units GC1, GC2, GC3, GC4 and GC5 according to embodiments of the present disclosure. FIG. 11F illustrates a cross-sectional view of the meta-grating units GC1, GC2, GC3, GC4 and GC5. Each of the meta-grating units includes a plurality of gratings 251. The gratings 251 includes one or more first gratings 252 and one or more second gratings 253. In one or more embodiments of the present disclosure, each of the meta-grating units GC1, GC2, GC3, GC4 and GC5 can be used as any of the input meta-grating units IGC, the fold meta-grating units FGC and the output meta-grating units OGC. The first gratings 252 of the meta-grating units GC1, GC2, GC3, GC4 and GC5 can be used as the first grating (such as the first grating 222, 232 or 242) of any of the input meta-grating units IGC, the fold meta-grating units FGC and the output meta-grating units OGC. The second gratings 253 of the meta-grating units GC1, GC2, GC3, GC4 and GC5 can be used as the first grating (such as the first grating 223, 233 or 243) of any of the input meta-grating units IGC, the fold meta-grating units FGC and the output meta-grating units OGC. The arrangement direction DA can be regarded as the corresponding arrangement direction of the gratings (such as the gratings 221, 222 or 223) of the input meta-grating units IGC, the fold meta-grating units FGC and the output meta-grating units OGC.

In the meta-grating unit GC1 as illustrated in FIG. 11A, the first grating 252 is a rectangle, the second grating 253 includes rectangle sub-gratings spaced apart from each other in a direction vertical to the arrangement direction DA. FIG. 11F illustrates a cross-section view along section C1-C1′ of FIG. 11A and parallel to the arrangement direction DA.

In the meta-grating unit GC2 as illustrated in FIG. 11B, the first grating 252 includes rectangle sub-gratings spaced apart from each other in a direction vertical to the arrangement direction DA, the second grating 253 includes strip sub-gratings spaced apart from each other in the direction vertical to the arrangement direction DA. FIG. 11F illustrates a cross-section view along section C2-C2′ of FIG. 11B and parallel to the arrangement direction DA.

In the meta-grating unit GC3 as illustrated in FIG. 11C, the first grating 252 includes rectangle sub-gratings spaced apart from each other in a direction vertical to the arrangement direction DA, the second grating 253 includes square sub-gratings spaced apart from each other in the direction vertical to the arrangement direction DA. FIG. 11F illustrates a cross-section view along section C3-C3′ of FIG. 11C and parallel to the arrangement direction DA.

In the meta-grating unit GC4 as illustrated in FIG. 11D, the first grating 252 includes rectangle sub-gratings spaced apart from each other in a direction vertical to the arrangement direction DA, the second grating 253 is a rectangle. FIG. 11F illustrates a cross-section view along section C4-C4′ of FIG. 11D and parallel to the arrangement direction DA.

In the meta-grating unit GC5 as illustrated in FIG. 11E, the first grating 252 is an oval grating with uneven widths in a direction parallel to the arrangement direction DA, the second grating 253 includes two oval sub-gratings spaced apart from each other in a direction vertical to the arrangement direction DA, and the two oval sub-gratings of the second grating 253 have different profiles with uneven widths in a direction parallel to the arrangement direction DA. FIG. 11F illustrates a cross-section view along section C5-C5′ of FIG. 11E and parallel to the arrangement direction DA.

In one or more embodiments of the present disclosure, the gratings 252 and 253 in the meta-grating units GC1, GC2, GC3, GC4, and GC5 shown in FIGS. 11A to 11E have the same profiles on the cross-sectional views corresponding to the sections C1-C1′, C2-C2′, C3-C3′, C4-C4′ and C5-C5′ and can equivalently regarded as the same meta-grating unit GC. As shown in FIG. 11F, in the meta-grating unit GC, the first grating 252 on the cross-sectional view has a profile aligned with a boundary of the periodic length TGC. The profile of the first grating 252 on the cross-sectional view has a width W1. The profile of the second grating 253 on the cross-sectional view has a width W2. A gap G1 is between the two-dimensional projection structure of the first grating 252 and the profile of the second grating 253 in the cross sectional view. The profile of the second grating 253 in cross-sectional view is spaced apart from the other boundary of the periodic length TGC by a gap G2. In one or more embodiments, the width W1 is greater than or equal to the width W2, and the ratio of the gap G1 to the gap G2 is in the range of 0.1 to 10. In one or more embodiments, the width W1 is greater than the width W2, and the ratio of the gap G1 to the gap G2 is in the range of 0.7 to 10.

Since the first grating 252 and the second grating 253 of the grating 251 are periodically arranged along the arrangement direction DA with the periodic length TGC, different meta-grating units with the same period length can be used to describe the arrangement of the same grating 251. For example, the meta-grating unit GC in FIG. 11F can be shifted along the arrangement direction DA by the width W1 and the gap G1 to define another meta-grating unit having a period length TGC and a boundary aligned with the second grating 253. The meta-grating unit starting at the second grating 253 includes the second grating 253, the gap G2, the first grating 252, and the gap G1 in the arrangement direction DA in order, wherein the width W2 is less than or equal to the width W1, and the ratio of the gap G1 to the gap G2 is in the range of 0.1 to 10. In one or more embodiments, the width W2 is less than the width W1, and the ratio of the gap G1 to the gap G2 is in the range of 0.7 to 10. After the meta-grating units of the second grating 253 are periodically arranged, the starting point can describe the same arrangement as the grating 251 described by the periodic arrangement of the meta-grating units GC in FIG. 11F. Furthermore, any meta-grating unit that can be arranged periodically to describe the grating 251 having the same arrangement as the meta-grating unit GC in FIG. 11F is also included in the present disclosure.

In one or more embodiments of the present disclosure, since the parallel gratings 251 of the meta-grating units GC1, GC2, GC3, GC4, and GC5 can be equivalently regarded as the meta-grating unit GC shown in the cross sectional view of FIG. 11F, the meta-grating units GC1, GC2, GC3, GC4 and GC5 can produce similar modulation characteristics when adjusting the diffraction efficiency of different orders of transmissive diffraction light and reflective diffraction light. In some embodiments, as shown in FIG. 11F, the periodic length TGC, the width W1, the width W2, gap G1 and gap G2 of the meta-grating unit GC can satisfy the requirements of conditions of the periodic length TGC, the width W1, the width W2, gap G1 and gap G2 for the width W1, the width W2, gap G1 and gap G2 of any one of the meta-grating unit (e.g., meta-grating unit IGC, FGC, OGC1, OGCM or OGC5) in FIGS. 2A, 3A, 4A, 5A, 6A, 7A, 8A and 9A to have similar diffraction modulation characteristics the reflective diffraction light and the transmissive diffraction light with different orders. In one or more embodiments of the present disclosure, each of the meta-grating units GC1, GC2, GC3, GC4, and GC5 can be used as any of the input meta-grating units IGC, the fold meta-grating units FGC, and the output meta-grating units OGC.

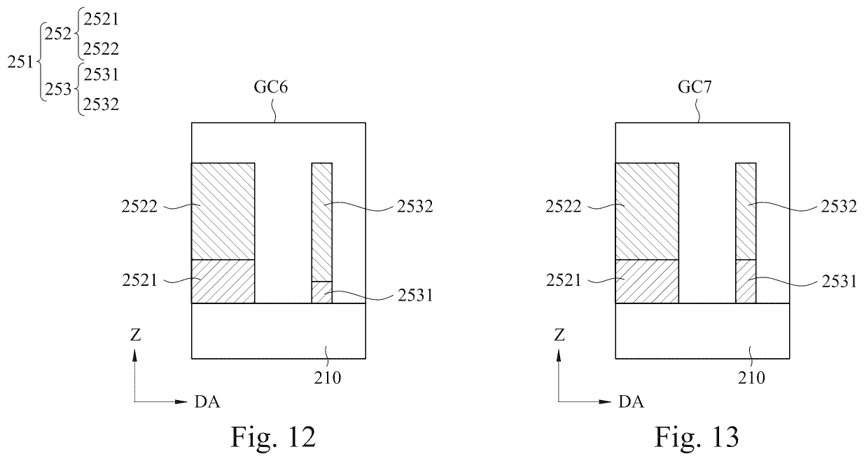

Reference is made to FIGS. 12 through 15. FIGS. 12 through 15 respectively illustrate a plurality of meta-grating units GC6, GC7, GC8, GC9 and GC10 according to embodiments of the present disclosure. Each of the meta-grating units GC6, GC7, GC8, GC9 and GC10 includes a plurality of gratings 251, and the gratings 251 include one or more first gratings 252 and one or more second gratings 253. In one or more embodiments of the present disclosure, each of the meta-grating units GC6, GC7, GC8, GC9 and GC10 can be used as any one of the input meta-grating units IGC, the fold meta-grating units FGC and the output meta-grating units OGC. The first grating 252 of the meta-grating units GC6, GC7, GC8, GC9 and GC10 can be used as the first grating (e.g., the first grating 222, 232 or 242) in any of the input meta-grating units IGC, the fold meta-grating units FGC and the output meta-grating units OGC. The second grating 253 (e.g., the second grating 223, 233 or 243) of the meta-grating units GC6, GC7, GC8, GC9 and GC10 can be used as the second grating in any one of the input meta-grating units IGC, the fold meta-grating units FGC and the output meta-grating units OGC. The arrangement direction DA can be considered as the arrangement direction of the gratings (e.g., the gratings 221, 222 or 223) in the input meta-grating units IGC, the fold meta-grating units FGC and the output meta-grating units OGC.

FIG. 12 illustrates that the first grating 252 of the meta-grating unit GC6 includes a first grating section 2521 and a second grating section 2522 above the first grating section 2521. The second grating 253 of the meta-grating unit GC6 includes a first grating section 2531 and a second grating section 2532 above the first grating section 2531. In some embodiments, the first grating sections 2521 and 2531 have the same grating material, the second grating sections 2522 and 2532 have the same grating material, and the grating material of the first grating sections 2521 and 2531 is different from the grating material of the second grating sections 2522 and 2532. In some embodiments, the refractive index of the grating material of the first grating sections 2521 and 2531 is different from the refractive index of the grating material of the second grating sections 2522 and 2532. In FIG. 12, the second grating sections 2522 and 2532 have different lengths in the Z direction. In some embodiments, the first grating 252 and the second grating 253 may be formed by the same etching process. For example, forming the first grating 252 and the second grating 253 may include forming a grating material layer of the first grating sections 2521 and 2531 on the substrate; recessing the grating material layer of the first grating sections 2521 and 2531 so that the grating material layer at the position of the first grating section 2531 is recessed; the grating material layer of the second grating sections 2522 and 2532 is formed on the grating material layer of the first grating sections 2521 and 2531, and the grating material layer of the second grating sections 2522 and 2532 is polished; and patterning the grating material layer of the first grating sections 2521 and 2531 and the grating material layer of the second grating sections 2522 and 2532 to form the first grating 252 and the second grating 253. Therefore, in the Z direction, the length of the second grating section 2522 of the first grating 252 is less than the length of the second grating section 2532 of the second grating 253.

FIG. 13 illustrates the meta-grating units GC7 where the first grating 252 includes a first grating section 2521 and a second grating section 2522 above the first section. The second grating 253 includes a first grating section 2531 and a second grating section 2532 above the first section. Compared to the meta-grating units GC6 shown in FIG. 12, in the meta-grating units GC7 depicted in FIG. 13, the second grating section 2522 of the first grating 252 and the second grating section 2532 of the second grating 253 have the same length in the Z direction.

FIG. 14 illustrates that the first grating 252 and the second grating 253 of the meta-grating units GC8 have different refractive indices from top to bottom in the Z direction. In some embodiments, for example but not limited to the present disclosure, the first grating 252 and the second grating 253 can be formed from a grating material layer on the substrate 210. Before patterning the grating material layer to form the first grating 252 and the second grating 253, the grating material layer can be doped with varying concentrations from top to bottom, resulting in the formed first grating 252 and the formed second grating 253 having different refractive indices from top to bottom.

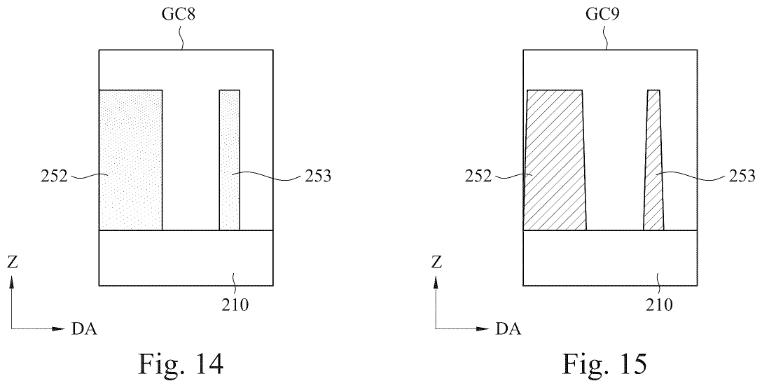

FIG. 15 illustrates that the first grating 252 and the second grating 253 of the meta-grating units GC9 have unequal widths from top to bottom in the arrangement direction DA, and the first grating 252 and the second grating 253 can still be periodically arranged along the arrangement direction DA to modulate the diffraction efficiency of light.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A waveguide structure, comprising:
a substrate;
an input grating region located on the substrate and comprising a plurality of input meta-grating units arranged periodically;
a fold grating region located on the substrate and comprising a plurality of fold meta-grating units arranged periodically, wherein the input grating region and the fold grating region are arranged in a first direction;
an output grating region located on the substrate and comprising a plurality of output grating sub-regions, wherein the output grating region is located at a side of the fold grating region, the fold grating region and the output grating region are arranged along a second direction different from the first direction, each of the output grating sub-regions comprises a plurality of output meta-grating units,
wherein each of the input meta-grating units, the fold meta-grating units and the output meta-grating units comprises a first grating and a second grating,
wherein in a periodic length of each of the input meta-grating units, the fold meta-grating units and the output meta-grating units,
the first grating in a cross-sectional view has a first profile, the second grating in the cross-sectional view has a second profile;
the first profile is at a first boundary of the periodic length and has a first width;
the second profile has a second width;
a first gap is between the first profile and the second profile; and
the second profile is spaced apart from a second boundary of the periodic length from a second gap, the first width is equal to or greater than the second width, and a ratio of the first gap and the second gap is in a range 0.1 to 10.

2. The waveguide structure of claim 1, wherein top surfaces of the first and second gratings of the input meta-grating units, the fold meta-grating units and the output meta-grating units have the same height.

3. The waveguide structure of claim 1, wherein in each of the input meta-grating units, the fold meta-grating units and the output meta-grating units, a ratio of the first gap and the second gap is in a range of 0.7 to 10 when the first width is greater than the second width.

4. The waveguide structure of claim 1, wherein in one of the input meta-grating units, the fold meta-grating units and the output meta-grating units, one of the first grating and the second grating comprises a plurality of sub-gratings spaced apart from each other in a direction vertical to the cross-sectional view.

5. The waveguide structure of claim 1, wherein each of the first gratings and the second grating comprises:
a first grating section on the substrate; and
a second grating section on the first grating section, wherein a refractive index of the first grating section is different from a refractive index of the second grating section.

6. The waveguide structure of claim 5, wherein a length of the second grating section of one of the first gratings is different from a length of the second grating section of one of the second gratings.

7. The waveguide structure of claim 1, wherein in one of the input meta-grating units of the input grating region,
the first width is greater than the second width;
the first gap is greater than the second gap;
a ratio of the periodic length of the input meta-grating units to the first width ranges from 2.4 to 2.8;
a ratio of the periodic length of the input meta-grating units to the first gap ranges from 2.7 to 3.9;
a ratio of the first width to the second width ranges from 2.7 to 3.8; and
a ratio of the first gap to the second gap ranges from 1.1 to 2.8.

8. The waveguide structure of claim 1, wherein the fold grating region comprises a front-end fold grating sub-region, a back-end fold grating sub-region and a plurality of middle fold grating sub-regions between the front-end fold grating sub-region and the back-end fold grating sub-region, wherein in one of the fold meta-grating units of the front-end fold grating sub-region,
the first width is equal to the second width;
the first gap is equal to the second gap;
a ratio of the periodic length of the fold meta-grating units of the front-end fold grating sub-region to the first width ranges from 2.6 to 6.2;
a ratio of the periodic length of the fold meta-grating units of the front-end fold grating sub-region to the first gap ranges from 2.6 to 7;
a ratio of the first width to the second width is equal to 1 or ranges from 1 to 1.2; and
a ratio of the first gap to the second gap ranges from 0.8 to 1.2.

9. The waveguide structure of claim 1, wherein the fold grating region comprises a front-end fold grating sub-region, a back-end fold grating sub-region and a plurality of middle fold grating sub-regions between the front-end fold grating sub-region and the back-end fold grating sub-region,
the first width is greater than the second width;
the first gap is unequal to the second gap;
a ratio of the periodic length of the fold meta-grating units of the back-end fold grating sub-region to the first width ranges from 4 to 6;
a ratio of the periodic length of the fold meta-grating units of the back-end fold grating sub-region to the first gap ranges from 2 to 3.6;
a ratio of the first width to the second width ranges from 1.02 to 3.4; and
a ratio of the first gap to the second gap ranges from 0.8 to 1.6.

10. The waveguide structure of claim 1, wherein the output grating sub-regions comprises a front-end output grating sub-region, a back-end output grating sub-region and one or more middle output grating sub-regions, in one of the output meta-grating units of the front-end output grating sub-region,
the first width is equal to the second width;
the first gap is equal to the second gap;
a ratio of the periodic length of the output meta-grating units of the front-end output grating sub-region to the first width ranges from 3.8 to 12;
a ratio of the periodic length of the output meta-grating units of the front-end output grating sub-region to the first gap ranges from 2.3 to 3.9;
a ratio of the first width to the second width is equal to 1 or ranges from 1 to 1.4; and
a ratio of the first gap to the second gap ranges from 1 to 10.

11. The waveguide structure of claim 1, wherein the output grating sub-regions comprises a front-end output grating sub-region, a back-end output grating sub-region and one or more middle output grating sub-regions, in one of the output meta-grating units of the one or more middle output grating sub-regions,
the first width is greater than the second width;
the first gap is unequal to the second gap;
a ratio of the periodic length of the output meta-grating units of the one or more middle output grating sub-regions to the first width ranges from 1.5 to 5.3;
a ratio of the periodic length of the output meta-grating units of the one or more middle output grating sub-regions to the first gap ranges from 2.5 to 11;
a ratio of the first width to the second width is equal to 1.1 or ranges from 1.1 to 3; and
a ratio of the first gap to the second gap ranges from 0.7 to 2.2.

12. The waveguide structure of claim 1, wherein the output grating sub-regions comprises a front-end output grating sub-region, a back-end output grating sub-region and one or more middle output grating sub-regions, in one of the output meta-grating units of the back-end output grating sub-region,
the first width is greater than the second width;
the first gap is greater than the second gap;
a ratio of the periodic length of the output meta-grating units of the back-end grating sub-regions to the first width ranges from 2.4 to 2.8;
a ratio of the periodic length of the output meta-grating units of the back-end grating sub-regions to the first gap ranges from 2.5 to 3.2;
a ratio of the first width to the second width is equal to 2.1 or ranges from 2.1 to 3; and
a ratio of the first gap to the second gap ranges from 2.5 to 3.1.

13. A waveguide structure, comprising:
a substrate;
an input grating region located on the substrate and comprising a plurality of input meta-grating units arranged periodically;
a fold grating region located on the substrate and comprising a plurality of fold meta-grating units arranged periodically, wherein the input grating region and the fold grating region are arranged in a first direction;
an output grating region located on the substrate and comprising a plurality of output grating sub-regions, wherein the output grating region is located at a side of the fold grating region, the fold grating region and the output grating region are arranged along a second direction different from the first direction, each of the output grating sub-regions comprises a plurality of output meta-grating units,
wherein each of the input meta-grating units, the fold meta-grating units and the output meta-grating units comprises a first grating and a second grating, top surfaces of the first and second gratings of the input meta-grating units, the fold meta-grating units and the output meta-grating units have the same height.
